(19) United States
(12) Patent Application Publication
(10) Pub. No.: US 2005/0002382 A1
(43) Pub. Date: Jan. 6, 2005

(54) Method and system for data transfer

(75) Inventors: Jyri P. Salomaa, Jorvas (FI); Pekka Lahtinen, Helsinki (FI); Pekka Laitinen, Helsinki (FI); Olli Rantapuska, Vantaa (FI); Juha Saarnio, Helsinki (FI); Jaakko Teinila, Espoo (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/880,283

(22) Filed: Jun. 29, 2004

(30) Foreign Application Priority Data
Jun. 30, 2003 (GB) 0315240.2

(51) Int. Cl. H04L 12/66

(52) U.S. Cl. 370/352; 370/401; 455/418; 709/202

(57) ABSTRACT

A communication system comprising a data communication network, a service provider and a communication terminal is described. The communication terminal includes a user interaction device, a processor, a memory and a character stored in the memory and capable of running on the processor and of providing a presence on the user interaction device. The communication system also comprises an agent residing in the data communication network being configurable to collect data from the service provider, of providing a continuous follow-up of occurrences in the network and of providing the data to the character. The character is configurable to approach the agent and to receive the data from the agent over a wireless link supported by the communication terminal and to present the data to the user by means of the user interaction device. Furthermore, a method for data transfer from a service provider to a communication terminal over a data communication network is described.

### FIELD OF THE INVENTION

The present invention relates to a communication system and to a method for data transfer from a service provider to a user over a data communication network.

### BACKGROUND OF THE INVENTION

Users may wish to receive a variety of information via a communication system. In particular, the user may wish to limit and/or choose the data received from the communication system. It might also be desirable to limit and/or choose the time of the data reception or control the manner of representation of the data.

The communication system can be seen as a facility that enables communication between two or more entities, such as user equipment or more generally network entities and other nodes associated with the communication system. User equipment may typically be a cellular phone or another device connected to a data communication network, such as Internet. The communication may comprise, for example, communication of various kinds of data such as voice data, electronic mail (email), text messages, content data, multimedia and so on.

Data retrieval may be used in a conventional solution for the transfer of information from information providers to user equipment. The user of a cellular telephone, such as a Wireless Applications Protocol (WAP) telephone, or other appropriate user equipment has to initiate the retrieval. The initiation by the user is needed before each retrieval. The telephone sends request, for example a Hypertext Transfer Protocol (HTTP) query, to an information provider. The information provider returns a HTTP response. Typically, the information is then immediately displayed to the user for example in a WAP browser.

Another conventional method for the transfer of information from information providers to user equipment may be based on the push method. In the push method, the user must make information subscriptions to information providers in advance. Based on the earlier subscriptions the information providers then autonomously send new instances of the subscribed information to the user equipment. The information ending up at the user equipment is not further selected by the user before it arrives. All the information based on the earlier subscriptions arrives at the user equipment. It may be up to the user equipment when the information will be displayed to the user. For example, certain variants of the WAP protocol support push services.

In both of these technologies, the user has a very limited way to have an impact on the time of the reception and on the presentation of the information in his equipment. The possibility to select the data is also very limited.

Therefore, there is a need for an improved system for data transfer from a service provider to a user over a data communication network.

### SUMMARY OF THE INVENTION

Embodiments of the present invention aim to address one or several of the above problems or issues.

According to the present invention, there is provided a communication system comprising a data communication network; a service provider; a communication terminal including a user interaction device, a processor, a memory and a character stored in the memory and capable of running on the processor and of providing a presence on the user interaction device; and an agent residing in the data communication network being configurable to collect data from the service provider, of providing a continuous follow-up of occurrences in the network and of providing the data to the character; the character being configurable to approach the agent and to receive the data from the agent over a wireless link supported by the communication terminal and to present the data to the user by means of the user interaction device.

According to the present invention, there is also provided a communication terminal comprising a user interaction device, a processor and a memory; and a character stored in the memory and capable of running on the processor and of providing a presence on the user interaction device, the character being configurable to receive data over a wireless link supported by the terminal from an agent residing in a data communication network, the agent being configurable to collect data from a service provider, and to present the data to the user by means of the user interaction device.

According to the present invention, there is also provided a method for data transfer from a service provider to a communication terminal over a data communication network, the method comprising the steps of providing data reception configurations to an agent residing in the data communication network for receiving data over a wireless link supported by the communication terminal from the agent to a character stored in a memory of the communication terminal and capable of running on the processor and of providing a presence on a user interaction device; collecting data by the agent from the service provider; providing the collected data from the agent to the character in accordance with the data reception configurations; and displaying the data to a user by means of the user interaction device being in contact with the character.

Preferably, the character may be configurable by means of the user interaction device to obtain data reception configurations of a user to indicate required data. In certain embodiments, the data reception configurations of a user may indicate at least one of the following: the type of the required data, the source of the required data, the form of the presentation of the data, the time of the presentation of the data or other indication concerning the nature of the information. The data may involve push of information and/or information requiring retrieval.

In certain preferred embodiments, the character may be capable of processing the received data.

Preferably, the agent may be configurable by means of the data reception configurations of a user. In certain preferred embodiments, the agent may be capable of processing the collected data. The agent may be capable of storing the collected data.

### BRIEF DESCRIPTION OF FIGURES

The invention will now be described in further detail, by way of example only, with reference to the following examples and accompanying drawings, in which:

FIG. 1 shows an example of an arrangement in which the embodiments of the present invention may be implemented.

FIG. 2 shows a flow chart according to the invention.

FIG. 3 shows a flow chart according to a preferred embodiment.

### DETAILED DESCRIPTION OF THE PREFERRED EMBODIMENTS

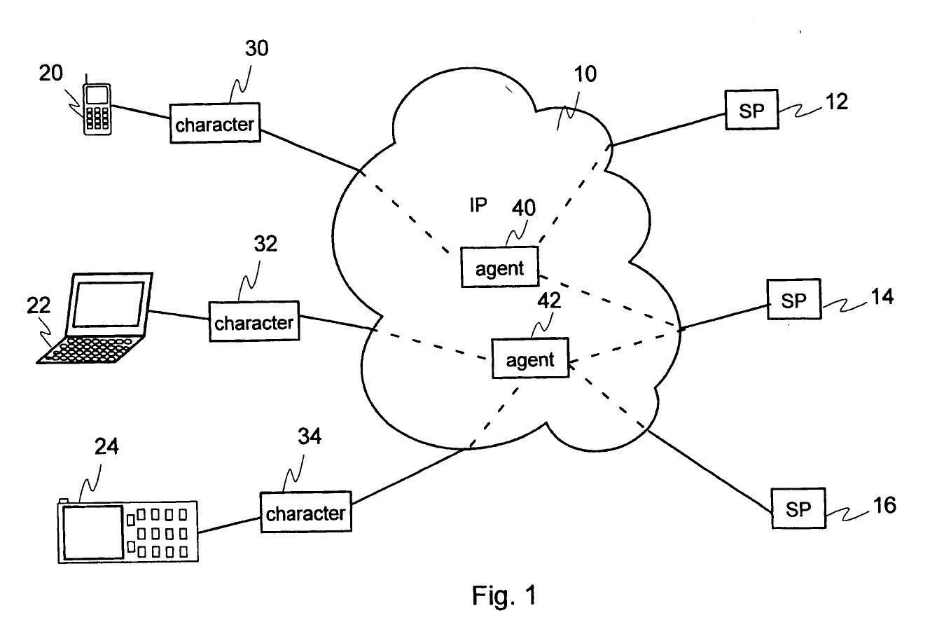

FIG. 1 shows an example of a communication system according to an embodiment of the present invention. The communication system of FIG. 1 comprises a data communication network 10, a plurality of service providers (SP) 12, 14 and 16, and a plurality of communication terminals 20, 22 and 24. In connection with the present invention, by service provider it is typically meant a system providing information or any other form of data service provisioning that may occur via a data communication network. The data service preferably provides data that is intended for presentation to an end-user of the network. The data communication network 10 may be any appropriate data communication network. In a preferred embodiment, the data communication network is provided at least in part by the Internet. The communication terminal may be any appropriate user equipment, such as a cellular phone, a computer provided with a network connection, or any other equipment operable according to a suitable network protocol, such as WAP or HTTP.

FIG. 1 shows also three characters 30, 32 and 34 stored in the memory of the communication terminals or interconnected with the memory of the communication terminal and configured for operation in accordance with the present invention. Furthermore, FIG. 1 shows two agents 40 and 42 residing in the data communication network and configured for operation in accordance with the present invention. Operation of the exemplifying characters and agents will become clear from the description below.

It shall be appreciated that FIG. 1 is only an example showing three service providers and three communication devices as well as three characters and two agents. The number of these entities may differ substantially from the shown. Herein after for simplicity, the service provider is referred to only with the reference numeral 12, the communication terminal only with 20, the character only with 30 and the agent only with 40.

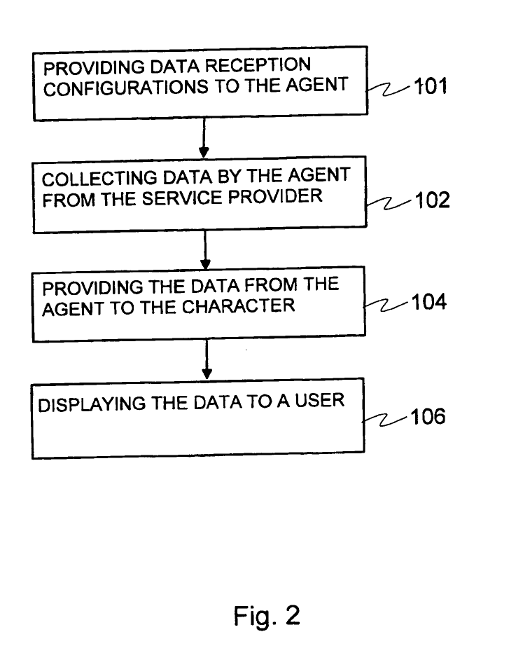

FIG. 2 shows a flow chart for a method in accordance of the invention. Data reception configurations to receive data from an agent 40 residing in the data communication network 10 to a character 30 stored in a memory of a communication terminal 20 over a wireless link supported by the communication terminal 20 are provided to the agent 40 in step 101. In step 102, the data is collected by the agent 40 from the service provider 12. The collected data is provided in step 104 from the agent 40 to the character 30 in accordance with the data reception configurations. In step 106, the data is displayed to a user by means of a user interaction device being in contact with the character 30.

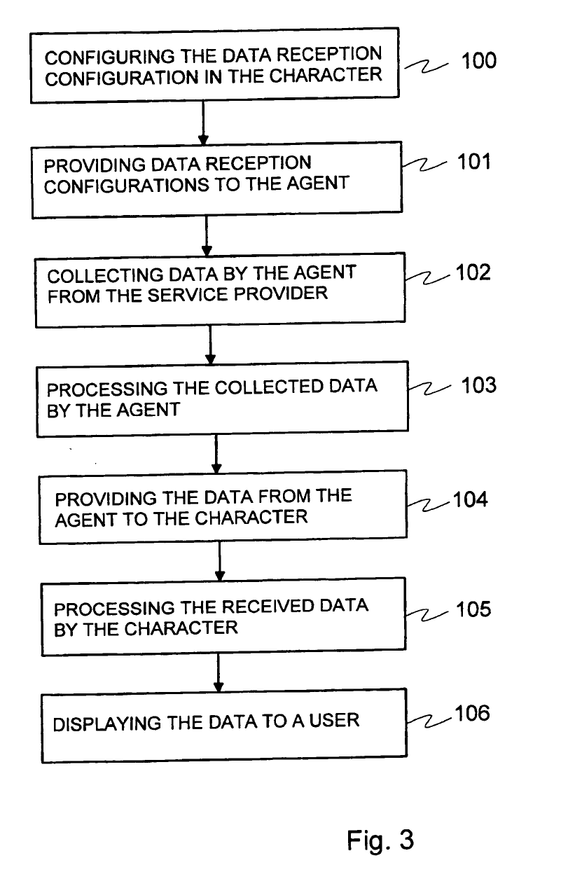

In a preferred embodiment, the method may also comprise further steps. The method according to a preferred embodiment is shown in FIG. 3. In step 100, the data reception configurations may be configured in the character 30 by means of a user interaction device comprised in the communication terminal 20. In step 103, the collected data may be processed by the agent 40. In step 105, the received data may be processed by the character 30.

In a preferred embodiment, a network resource is associated with a communication terminal 20 and the network resource hosts an agent 40. The network resource might, for example, be a server used for backing up communication terminal data for the user. The communication terminal 20 includes a memory and there is a character 30 stored in the memory. The communication terminal 20 includes also a user interaction device and a processor. The character 30 is able to run the processor and provides a presence on the user interaction device. In other words, the character 30 is configured to exist on the user interaction device at least when the character 30 is activated. The activation may be done automatically when the user interaction device is turned on and the character 30 may stay active persistently when the user interaction device is on. Alternatively, the activation of the character 30 might require some action from the user. The user interaction device may be a display provided with an appropriate user interface or any other type of user interaction device.

The character 30 is configurable by the user for indicating required data. The user may configure his preferences or instructions for the data reception by means of the character 30. The user may indicate for example the type and/or the source of information he wants to receive, the form and/or the time of the presentation of the received information and/or any other indication concerning the nature of the information. The information reception may result from both push of information and information requiring retrieval.

As an example, the character could be a customizable screen saver program stored in the memory of the communication terminal, such as a cellular phone. It might also be possible that the character is a separate entity connected either internally or externally to the user equipment, still however being interconnected with the memory of the communication terminal. Storing the character in the memory is meant to signify also this type of situation.

The character 30 may process the data reception configurations of the user. For example, there might be settings concerning only the function of the character 30 and those relating to the agent 40. The character 30 then provides the data reception configurations to the agent 40 residing in the network. Preferably, only the settings concerning the agent are sent to the agent.

The agent 40 acts on behalf of the communication terminal 20 in the network. Thus the communication terminal 20 is associated with an agent 40. In certain embodiments, the communication terminal 20 may be associated with a plurality of agents 40. One agent 40 can serve one or more user equipments 20 simultaneously.

The agent 40 is configurable to collect data from the service provider(s) 12. Preferably, the agent 40 collects the data following the data reception configurations of the user(s) received from the character 30 or from several characters. The agent 40 may make timed retrievals to query for new or updated information from retrieval based service providers. The agent may receive push information transmissions from push based service providers.

The agent 40 provides a continuous follow-up of occurrences in the network 10. The agent 40 stays permanently “awake” so that it may monitor persistently any approaches from the character(s) 30 associated with it or any approaches from any service provider 12 being able to have a connection with the agent 40 by the network 10. The approaches from the character 30 may comprise, for example, a request for data, an indication that the character 30 is ready to receive data or information of the data reception configurations of the user.

The agent 40 may also observe any other occurrences in the network possibly having an effect on the function of the agent 40 or of the character 30 or the communication terminal 20.

When the agent 40 has collected the required data, it may optionally process it further. Typically, the agent 40 may select only desired parts of the collected data, reorganize the data or make certain conclusions based on the data. The processing in the agent 40 may be carried out using any appropriate software, which may be configured depending on the desired function of the agent 40.

In a preferred embodiment, the bulk of the data is stored in the agent 40. In such a way, the use of expensive memory space may be controlled by the agent 40.

Preferably, the character 30 may also control the data storage. The character 30 may for example send suitable indications to the agent 40 when it is ready or willing to receive data. User never looses information, since the agent is there to receive the data at any moment even if the communication terminal 20 is not in function or otherwise capable of receiving data. This is advantageous in particular in the case of push information.

The display of the information to the user may be managed by the character 30 and may take place as indicated by the user in his data reception configurations. Also the character 30 may process the information to put it in a special format or choose a certain time for displaying the information. Since the information to be displayed to the user may be processed by the agent 40 and by the character 30, highly dissimilar information sources, such as HTML pages, text databases, electronic mail distributions and so on, can be given a uniform display, in particular look and feel, at the user interaction device of the communication terminal 20. The data is then sent from the agent 40 to the character 30. The expensive radio path is thus used only in a controlled manner for transferring pre-selected data between the agent 40 and the character 30.

The character 30 is configured to receive the data from the agent 40. The data may be transferred from the agent 40 to the character 30 using any appropriate transfer technology, an example being the push technology. If the push technology is used, the character 30 may send a signal to the agent 40 when becoming active thus allowing push operations or passive thus suppressing further push operations. Alternatively, the agent 40 may send queries to the character 30 to find out the status of the character 30. This may be done when the agent 40 wishes to send data to the character 30. It may also be a continuous survey so that the agent 40 sends a query of the status of the character 30 for example in predefined intervals.

An alternative transfer technology might be broadcasting, such as Digital Video Broadcasting Terrestial. Broadcasting enables the data to be sent to a plurality of characters at the same time. Broadcasting may thus be used when the agent serves several characters simultaneously. If more than one character requires the same data, broadcasting may be an advantageous transfer technology.

One exemplary way of organizing information in the agent 40 might be to define channels. The communications terminals 20 may indicate from which channels they wish to receive data. In the channel scenario, the agent software instance may make available information channels whose available selection may depend on the operator of the agent software instance. Cellular network operators, various web portal operators and so on might provide agents 40. The user of a telephone or other communication terminal 20 then may use a selection process to his information service. The selection might include the steps of picking an agent operator, choosing the channels to follow, choosing the character application and customizing it to display the chosen channels. The steps may be separate or two or several steps may be carried out simultaneously. There may naturally be more steps or less steps depending on the actual configuration of the character 30 and the agent 40. It should be appreciated that the organization of the information or the data is not limited to the channel scenario, but may be implemented in any other suitable way.

In an embodiment, if for example news-like information services are used, the character 30 might only show the titles of the news items on its own-implemented user interface. Whenever the user wants to see a full news item, a standard WAP or HTML browser of the telephone could be launched to view the news text. As an implementation example, the news titles passed from the agent 40 to the character 30 may consist for example of the title text, the URL of the full content text, and a per-viewing fee if the full content text is payable. Title text and fee may be shown to user. If user selects a title, i.e. makes an action indicating that he wishes to see the full content text associated with the title, and optionally accepts to pay the fee, the character may launch another browser application and pass the URL to it. This may cause the browser to fetch the full content text from the URL and to display it.

There may be one or several characters 30 connected to one communication terminal 20. One character 30 may carry out a plurality of different functions. Alternatively, there might be a character 30 for each type of function. A function may for example be associated with the type of data or the way of presenting the data. For example, there might be different functions for processing news data in a text format or in a multimedia format. Furthermore, entertainment data, such as games, may represent a different function from informational data, such as a whether forecast. It may also be possible that the character 30 observes its environment autonomously. For example, the character 30 may observe temperature or lightness changes, vigorous phone movement or loud voice. The character 30 may also observe phone status conditions, such as low battery or full short message storage. For these purposes, the communication terminal 20 is provided with appropriate means, such as a sensor or the like. The character 30 may also be configured to express any other event. It may for example be possible that the character 30 has an expression for a situation when the communication terminal 20 has not been used for a while or if the user tries to make any forbidden or impossible functions. The information from the observations made by the character 30 autonomously may be treated individually or may be combined with the data received from the agent 40.

The character 30 may allow the user to change or customize his settings any time. The changes are advantageously processed in the character 30 so that the agent 40 only receives information which changes or is additional to the settings it already has. The display of information can be highly customized by first selecting a character with right capabilities and then customizing those capabilities. The display of information may always happen on the user's own terms, since there is no interruptive random receptions of push information, needs to purge out information from the filling phone memory, and the like.

The character 30 and the agent 40 are associated and typically act in close concert. However, when the agent 40 already possesses the data reception configurations, the agent 40 can be accessed from any other communication terminal than the communication terminal 20 connected to the character 30 being associated with the agent 40. For example, the user might not have his telephone or a suitable cellular network at hand, but has an access to the Internet by means of a computer. He may then use a web browser provided with suitable security measures to retrieve the data available in the agent 40 and processed in accordance to his data reception configurations by the agent 40.

The character 30 and the agent 40 may be associated with other features of the communication terminal 20. For example, they may support also spontaneous information access, such as spontaneous browsing in the Internet, electronic mail reception and access and so on.

As is clear from the description above, the invention may provide various advantages over the prior art. The communication between the communication terminal 20 and the network 10 may be optimized since individual push data transfer no more need to extend to the communication terminal 20, but to the agent 40 only. Push-like retrieval may make available information sources not supporting push techniques without user's repeated explicit retrieval. The character 30 may enable customizing the user's interface to the information in an optimal and/or desired way.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A communication system comprising
a data communication network;
a service provider;
a communication terminal including a user interaction device, a processor, a memory and a character stored in the memory and capable of running on the processor and of providing a presence on the user interaction device; and
an agent residing in the data communication network being configurable to collect data from the service provider, of providing a continuous follow-up of occurrences in the network and of providing the data to the character;
the character being configurable to approach the agent and to receive the data from the agent over a wireless link supported by the communication terminal and to present the data to the user by means of the user interaction device.

2. The communication system according to claim 1, wherein the character is configurable by means of the user interaction device to obtain data reception configurations of a user to indicate required data.

3. The communication system according to claim 2, wherein the data reception configurations of a user indicate at least one of the following: the type of the required data, the source of the required data, the form of the presentation of the data, the time of the presentation of the data or other indication concerning the nature of the data.

4. The communication system according to claim 1, wherein the data involves push of information.

5. The communication system according to claim 1, wherein the data involves information requiring retrieval.

6. The communication system according to claim 2, wherein the agent is configurable by means of the data reception configurations of a user.

7. The communication system according to claim 1, wherein the agent is capable of processing the collected data.

8. The communication system according to claim 1, wherein the agent is capable of storing the collected data.

9. The communication system according to claim 1, wherein the character is capable of processing the received data.

10. A communication terminal comprising
a user interaction device, a processor and a memory; and
a character stored in the memory and capable of running on the processor and of providing a presence on the user interaction device,
the character being configurable to receive data over a wireless link supported by the terminal from an agent residing in a data communication network, the agent being configurable to collect data from a service provider, and the character being configurable to present the data to the user by means of the user interaction device.

11. The communication terminal according to claim 10, wherein the character is configurable by means of the user interaction device to obtain data reception configurations of a user.

12. The communication terminal according to claim 10, wherein the character is capable of processing the collected data.

13. A method for data transfer from a service provider to a communication terminal over a data communication network, the method comprising the steps of providing data reception configurations to an agent residing in the data communication network for receiving data over a wireless link supported by the communication terminal from the agent to a character stored in a memory of the communication terminal and capable of running on the processor and of providing a presence on a user interaction device;
collecting data by the agent from the service provider;
providing the collected data from the agent to the character in accordance with the data reception configurations; and
displaying the data to a user by means of the user interaction device being in contact with the character.

14. The method according to claim 13, comprising the further step of configuring the data reception configurations in the character by means of a user interaction device comprised in the communication terminal.

15. The method according to claim 13, comprising the further step of processing the data collected by the agent.

16. Transfer apparatus for data transfer from a service provider to a communication terminal over a data communication network, the transfer apparatus comprising
first providing function for providing data reception configurations to an agent residing in the data communication network for receiving data over a wireless link supported by the communication terminal from the agent to a character stored in a memory of the communication terminal and capable of running on the processor and of providing a presence on a user interaction device;
collecting function for collecting data by the agent from the service provider; second providing function for providing the collected data from the agent to the character in accordance with the data reception configurations; and
displaying function for displaying the data to a user by means of the user interaction device being in contact with the character.

17. The transfer apparatus according to claim 16, further comprising configuring function for configuring the data reception configurations in the character by means of a user interaction device comprised in the communication terminal.

18. The transfer apparatus according to claim 16, further comprising processing function for processing the data collected by the agent.
